(19) United States
(12) Patent Application Publication
(10) Pub. No.: US 2025/0219552 A1
(43) Pub. Date: Jul. 3, 2025

(54) SYSTEM AND METHOD FOR BLENDED INTEGRAL-PROPORTIONAL/PROPORTIONAL-INTEGRAL (IPPI) CONTROLLERS FOR VOLTAGE SOURCE CONVERTERS

(71) Applicant: University of Central Florida Research Foundation, Inc., Orlando, FL (US)

(72) Inventors: Qifeng Li, Orlando, FL (US); Chiebuka Eyisi, Orlando, FL (US); Santosh Sharma, Orlando, FL (US)

(21) Appl. No.: 18/930,370

(22) Filed: Oct. 29, 2024

Related U.S. Application Data
(60) Provisional application No. 63/615,996, filed on Dec. 29, 2023.

(51) Int. Cl. H02M 7/483; G05B 19/4155; H02M 1/00

(52) U.S. Cl. CPC H02M 7/4835; G05B 19/4155; H02M 1/0016; G05B 2219/42351

(57) ABSTRACT

An integral-proportional (IP)/proportional-integral (PI) (IPPI) controller is blended through a single parameter for voltage and current control. When the parameter is optimized, the IPPI controller delivers a superior transient response, improved stability margins, and wider operating ranges for voltage source converters (VSCs) in comparison to conventional standalone PI controllers.

### CROSS-REFERENCE TO RELATED APPLICATIONS

This application claims priority to U.S. Provisional Patent Application No. 63/615,996 entitled, “SYSTEM AND METHOD FOR BLENDED INTEGRAL-PROPORTIONAL/PROPORTIONAL-INTEGRAL (IPPI) CONTROLLERS FOR VOLTAGE SOURCE CONVERTERS”, filed on Dec. 29, 2023, the entirety of which is incorporated herein by reference.

### FEDERALLY SPONSORED RESEARCH OR DEVELOPMENT

This invention was made with Government support under U.S. National Science Foundation Award No.: ECCS 1808988. The government has certain rights in the invention.

### BACKGROUND OF THE INVENTION

The interconnection between locally operated loads and one or more distributed energy resources (DERs), including energy storage systems (ESSs) and distributed generation (DGs), as an independent controllable entity is what constitutes a microgid (MG). Two-stage power conversion structures consisting of DC-DC boost converter and DC-AC voltage source converter (VSC) subsystems can facilitate the integration of DERs such as ESSs or solar photovoltaic systems (PVs) in MG networks, in which the low fluctuating output voltage of the resource is increased by the boost converter to a high regulated DC-link voltage fed to the VSC, A voltage source converter-based microgrid (VSC-MG) operating in either islanded or grid-connected mode requires a control method to aid in maintaining the operational limits of bus voltages, network frequencies, and injected currents, while also improving transient responses to system disturbances and preserving stability.

Instability in VSC-MGs can be caused by poorly tuned controllers, and until the controller is re-tuned, the system cannot be stabilized, A challenging issue for VSCs in relation to small-signal stability is the tuning of voltage and current controllers. This becomes more challenging under varying operating conditions. The conventional proportional-integral (PI)-based control method is the most used control method in VSCs, incorporating an outer voltage controller and an inner current controller developed in a synchronously rotating d-q reference frame. In MG networks, stability assessment via small-signal analysis (eigenvalue, sensitivity and participation factor analyses) requires appropriate state-space models of each component in the network. In addition, stability assessment requires inclusion of DC-side dynamics in the state-space modeling thereby introducing dynamic coupling between both VSC and boost converter subsystems.

In relation to preserving stability, an expansion of stability margins could translate to a higher degree of utilization and wider operating regions for the DER. Transients in VSC-MGs drive the system close to its operational limits which may cause these limits to be violated and potentially lead to instability. In PI controllers, the proportional and integral coefficients act on the error between the reference input command and the controlled output. However, the PI controller has a sluggish response, experiences a large overshoot, and is sensitive to the proportional and integral coefficients, Overshoots can lead to instability and may stress components within the VSC-MG.

In integral-proportional (OP) controllers, the integral coefficient acts on the error between the reference input command and the controlled output, while the proportional coefficient acts on the controlled output. Hence the proposed integral-proportional/proportional-integral (IPPI) controller, i.e., a combination of the PI and IP controllers, is a two degree-of-freedom (2 DOF) controller as the response to the input command and the response to the disturbance can be optimized independently. An IP controller is known to be used as a position controller for a synchronous motor and to improve the performance of DC and AC motor drives. It has also been used for DC-link voltage control in shunt active power filters and for rotor current control in doubly-fed induction generators. The IP controller overcame the drawbacks of the PI controller in these applications, particularly reducing the large overshoot. However, the IP controller experiences a large rise time, indicative of a slower response. Additionally, a PI controller designed for one operating condition may not perform well for another operating condition. For operating conditions close to operational limits, the problem of fast mitigation of transients becomes very important.

Accordingly, what is needed in the art is an improved controller for a VSC subsystem to interconnect distributed energy resources (DERs) to an electric power system, especially a microgrid (MG), which is more vulnerable.

### SUMMARY OF INVENTION

Embodiments of the present invention allow for a more effective utilization of distributed energy resources (DERs) in microgrids (MGs) and avoid violating operational limits of the asset, it is important that the stability and transient behavior or response of quantities such as voltages and currents is improved and maintained at appropriate levels. In various embodiments, the present invention provides a novel controller that enhances the safety, security, and reliability of electric power systems where DERs including intermittent renewable energy is integrated. As the penetration of DERs increases, this invention enables wider operating ranges for the VSCs, and consequently, high capital investments for major reinforcements in the power system to meet the increasing energy needs of its customers can be delayed.

In one embodiment, a controller for use in a voltage source converter (VSC) subsystem is provided. The controller incorporates both PI and IP control for voltage and current controllers through a blending factor α. The blending factor α is optimized to enhance damping characteristics and preserve stability for a desired system performance of the VSC subsystem.

In a particular embodiment, the blending factor α is optimized by solving:

$$\begin{matrix}{min}_{α} {\sum }_{m = 1}^{M} {σ}_{m} \\ s . t . \{ \begin{matrix}0 \leq {α}_{n} \leq 1 & ( n = 1 , 2 , … , N ) \\ \begin{matrix}{σ}_{0} \leq {σ}_{m} \leq 0 \\ {ζ}_{0} \leq {ζ}_{m}\end{matrix} & ( m = 1 , 2 , … , M )\end{matrix}\end{matrix}$$

where αₙ represents the blending factor of the IPPI current controller and the IPPI voltage controller for the nth VSC of the VSC-MG network, wherein M is the number of modes, wherein σ₀≤σₘ≤0 and ζ₀≤ζₘ are imposed simultaneously, wherein σₘ and ζₘ are a real part and damping ratios of the mth mode, respectively, wherein α₀ and ζ₀ are corresponding desirable system performance metrics.

In an additional embodiment, a voltage source converter (VSC) subsystem is provided. The VSC subsystem may include a DC-AC VSC, a power controller, a virtual impedance model block, an inductor-capacitor-inductor (LCL) filter and dead-time model block, a digital control emulator (DCE) model block, an inner IPPI current controller and an outer IPPI voltage controller, wherein the inner IPPI current controller and the outer IPPI voltage controller incorporates both PI and IP control through a blending factor α.

The invention also provides for a method for controlling a voltage source converter (VSC). The method including incorporating a controller into a VSC subsystem. The controller includes an integral-proportional/proportional-integral (IPPI) current controller and an IPPI voltage controller, wherein the IPPI current controller and the IPPI voltage controller incorporates both PI and IP control through a blending factor α, wherein the blending factor α is optimized.

As such, in various embodiments the present invention provides an improved controller for a VSC subsystem to interconnect distributed energy resources (DERs) to an electric power system, and in particular a microgrid (MG).

This invention positions itself as a key player for integrating DERs through VSCs in the power system, marking a pivotal leap forward in reducing carbon emissions in the United States. This invention holds immense promise for transitioning today's power system to the future smarter grid, which is greener and more intelligent, and contributing towards the zero-carbon goals of the United States Government.

### BRIEF DESCRIPTION OF THE DRAWINGS

For a fuller understanding of the invention, reference should be made to the following detailed description, taken in connection with the accompanying drawings, in which:

FIG. 1 illustrates a circuit diagram of a voltage source converter (VSC) subsystem comprising a proposed integral-proportional/proportional-integral (IPPI) voltage controller and a IPPI current controller, in accordance with an embodiment of the present invention.

FIG. 2 illustrates a circuit diagram of an IPPI-based voltage controller, in accordance with an embodiment of the present invention.

FIG. 3 illustrates a circuit diagram of an IPPI-based current controller, in accordance with an embodiment of the present invention.

FIG. 4 illustrates an IPPI control loop, in accordance with an embodiment of the present invention.

FIG. 5 is a graphical illustration of a step response characteristic for various blending factors of the IPPI control loop, in accordance with an embodiment of the present invention.

FIG. 6 illustrates a boost converter subsystem spanning from its input terminals to the input terminals of a VSC subsystem, in accordance with an embodiment of the present invention.

FIG. 7 is a circuit diagram illustrating a boost converter power model, in accordance with an embodiment of the present invention.

FIG. 8 is a circuit diagram illustrating a text VSC-MG network, in accordance with an embodiment of the present invention.

FIG. 9 is a graphical illustration of an objective function convergence, in accordance with an embodiment of the present invention.

FIG. 10 is a graphical illustration of output VSC currents and voltages from DGs for α=0.7, in accordance with an embodiment of the present invention.

FIG. 11 is a graphical illustration of output VSC currents and voltages from DGs for α=opt, in accordance with an embodiment of the present invention.

FIG. 12 is a graphical illustration of active and reactive power outputs from DGs for α=1, in accordance with an embodiment of the present invention.

FIG. 13 is a graphical illustration of injected grid currents from DGs for α=1, in accordance with an embodiment of the present invention.

FIG. 14 is a graphical illustration of output capacitor voltages from DGs for α=1, in accordance with an embodiment of the present invention.

FIG. 15 is a graphical illustration of droop-governed VSC frequency from DGs for α=1, in accordance with an embodiment of the present invention.

FIG. 16 is a graphical illustration of active and reactive power outputs from DGs for α=opt, in accordance with an embodiment of the present invention.

FIG. 17 is a graphical illustration of injected grid currents from DGs for α=opt, in accordance with an embodiment of the present invention.

FIG. 18 is a graphical illustration of output capacitor voltages from DGs for α=opt, in accordance with an embodiment of the present invention.

FIG. 19 is a graphical illustration of droop-governed VSC frequency from DGs for α=opt, in accordance with an embodiment of the present invention.

### DETAILED DESCRIPTION OF THE INVENTION

The utilization of renewable energy resources (RERs) like wind and solar energies is considered pivotal in the global efforts of reducing carbon emissions and addressing climate change. Towards a zero-carbon future, the United States Department of Energy (U.S. DOE) has undertaken an initiative to promote the expansion of the renewable energy sector in the country. Distributed energy resources (DERs), including RERs and other energy resources like battery energy storage, require power electronic converters, such as voltage source converters (VSCs), to connect these resources to the power grid. Given that these DERs are intermittent energy resources, to allow a more effective utilization of DERs in power systems, especially in the vulnerable microgrids (MGs), and avoid violating operational limits of the asset and even system collapses, it is important that the stability and transient behavior or response of quantities such as voltages and currents is improved and maintained at appropriate levels.

In various embodiments, the present invention provides an integral-proportional (IP) controller integrated with a proportional-integral (PI) controller to improve the performance of the disturbance rejection and input command tracking simultaneously, where both controllers are incorporated through a blending factor. The blended integral-proportional/proportional-integral (IPPI) controller combines the desirable attributes from both controllers and allows a more effective utilization of the VSC-interfaced DG and avoids violating its operational limits.

This invention develops small-signal state-space models for blended IPPI voltage and current controllers, and investigates their behavior and small signal stability in a VSC-MG. The results of the model are compared with the conventional PI-based voltage and current controllers on an islanded test VSC-MG network with DGs integrated through VSC and boost converter subsystems.

It is shown that the blended IPPI-based voltage and current controllers provide an added flexibility compared to the conventional PI-based voltage and current controllers in a VSC, allowing a more effective utilization. The proposed objective function within an optimization framework is effective in selecting appropriate blending factors to enhance the damping characteristics and preserve stability for a desirable system performance.

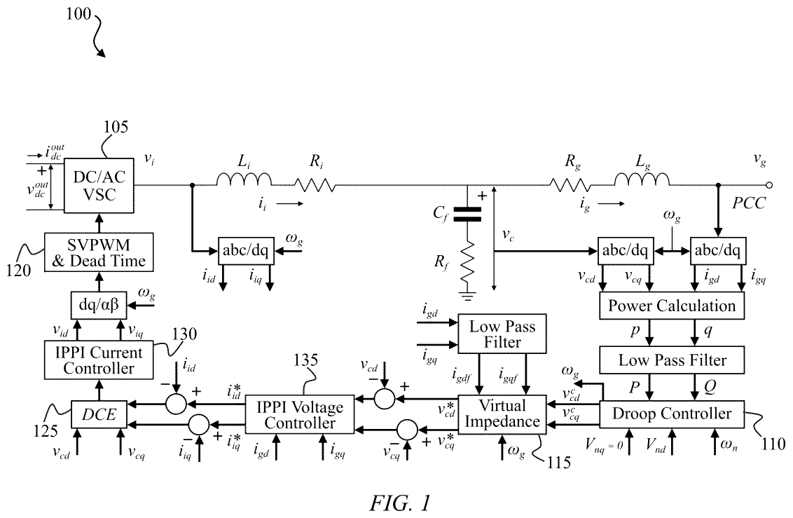

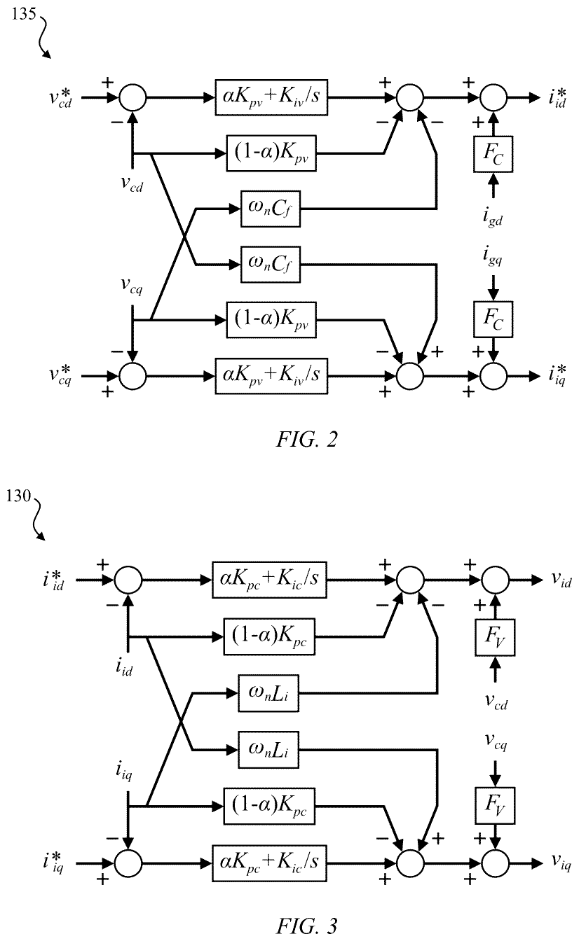

The VSC subsystem 100 spanning from its input terminals to the point of common coupling (PCC) is shown in the FIG. 1. Components within this subsystem 100 include the VSC 105, the power controller 110, the virtual impedance model block 115, the inductor-capacitor-inductor (LCL) filter and dead-time model block 120, the digital control emulator (DCE) model block 125, and the inner IPPI current controller 130 and outer IPPI voltage controller 135. FIG. 2 and FIG. 3 represents the IPPI voltage controller 135 and the IPPI current controller 130, respectively, illustrating the application of the blending factor α∈[0, 1], where if α=1 results in a PI controller, whereas if α=0 results in an IP controller.

The IPPI-based outer voltage controller 135 is shown in FIG. 2 where the state and algebraic equations are:

$$\begin{matrix}{\dot{ϕ}}_{d} = {v}_{c d}^{*} - {v}_{c d} , & {\dot{ϕ}}_{q} = {v}_{c q}^{*} - {v}_{c q} ,\end{matrix} \qquad ( 1 )$$

$${i}_{id}^{*} = {K}_{iv} {ϕ}_{d} + α {K}_{pv} ( {v}_{c d}^{*} - {v}_{c d} ) - ( 1 - α ) {K}_{pv} {v}_{c d} - {ω}_{n} {C}_{f} {v}_{cq} + {F}_{C} {i}_{gd} \qquad ( 2 )$$

$${i}_{iq}^{*} = {K}_{iv} {ϕ}_{q} + α {K}_{pv} ( {v}_{c q}^{*} - {v}_{c q} ) - ( 1 - α ) {K}_{pv} {v}_{c q} - {ω}_{n} {C}_{f} {v}_{cd} + {F}_{C} {i}_{gq} \qquad ( 3 )$$

By linearizing and combining (1), (2), and (3), the corresponding state-space model is as shown:

$$[ \begin{matrix}Δ {\dot{ϕ}}_{d} \\ Δ {\dot{ϕ}}_{q}\end{matrix} ] = {\underbrace{[ \begin{matrix}0 & 0 \\ 0 & 0\end{matrix} ]}}_{{A}_{{V}_{vsc}}} [ \begin{matrix}{Δϕ}_{d} \\ {Δϕ}_{q}\end{matrix} ] + {\underbrace{[ \begin{matrix}1 & 0 \\ 0 & 1\end{matrix} ]}}_{B {1}_{{V}_{vsc}}} [ \begin{matrix}Δ {v}_{c d}^{*} \\ Δ {v}_{c q}^{*}\end{matrix} ] + {\underbrace{[ \begin{matrix}- 1 & 0 \\ 0 & - 1\end{matrix} ]}}_{B {2}_{{V}_{vsc}}} [ \begin{matrix}Δ {v}_{c d} \\ Δ {v}_{c q}\end{matrix} ] \qquad ( 4 )$$

$$[ \begin{matrix}Δ {i}_{id}^{*} \\ Δ {i}_{iq}^{*}\end{matrix} ] = {\underbrace{[ \begin{matrix}{K}_{iv} & 0 \\ 0 & {K}_{iv}\end{matrix} ]}}_{{C}_{{V}_{vsc}}} [ \begin{matrix}{Δϕ}_{d} \\ {Δϕ}_{q}\end{matrix} ] + {\underbrace{[ \begin{matrix}α {K}_{pv} & 0 \\ 0 & α {K}_{pv}\end{matrix} ]}}_{D {1}_{{V}_{vsc}}} [ \begin{matrix}Δ {v}_{c d}^{*} \\ Δ {v}_{c q}^{*}\end{matrix} ] + {\underbrace{[ \begin{matrix}- {K}_{pv} & - {ω}_{n} {C}_{f} \\ {ω}_{n} {C}_{f} & - {K}_{pv}\end{matrix} ]}}_{D {2}_{{V}_{vsc}}} [ \begin{matrix}Δ {v}_{c d} \\ Δ {v}_{c q}\end{matrix} ] + {\underbrace{[ \begin{matrix}{F}_{C} & 0 \\ 0 & {F}_{C}\end{matrix} ]}}_{D {3}_{{V}_{vsc}}} [ \begin{matrix}Δ {i}_{gd} \\ Δ {i}_{gq}\end{matrix} ] \qquad ( 5 )$$

where \dot{ϕ}_{dq} is the error between the measured output capacitor voltage v_{cdq} and the reference output capacitor voltage v*_{cdq} in the d-q reference frame. The d-q components of the injected grid current and VSC output current reference are i_{gdq} and i*_{idg} respectively. This voltage controller compares v*_{cdq} with v_{cdq} to generate i*_{idq}. F_{C} is the feed-forward control gain of the injected grid current i_{gdq}. The nominal frequency operating point is ωₙ. C_{f} models the filter capacitance of the LCL filter. The proportional and integral coefficients of the voltage controller are Kₚᵥ and Kᵢᵥ, respectively.

The IPPI-based inner current controller 130 is shown in FIG. 3 where the state and algebraic equations are

$$\begin{matrix}{\dot{γ}}_{d} = {i}_{id}^{*} - {i}_{id} , & {\dot{γ}}_{q} = {i}_{iq}^{*} - {i}_{iq}\end{matrix} \qquad ( 6 )$$

$${v}_{id} = {K}_{ic} {γ}_{d} + α {K}_{pc} ( {i}_{id}^{*} - {i}_{id} ) - ( 1 - α ) {K}_{pc} {i}_{id} - {ω}_{n} {L}_{i} {i}_{iq} + {F}_{V} {v}_{c d} \qquad ( 7 )$$

$${v}_{iq} = {K}_{ic} {γ}_{q} + α {K}_{pc} ( {i}_{iq}^{*} - {i}_{iq} ) - ( 1 - α ) {K}_{pc} {i}_{iq} - {ω}_{n} {L}_{i} {i}_{id} + {F}_{V} {v}_{c q} \qquad ( 8 )$$

By linearizing and combining (6), (7), and (8), the corresponding state-space model is as shown:

$$[ \begin{matrix}Δ {\dot{γ}}_{d} \\ Δ {\dot{γ}}_{q}\end{matrix} ] = {\underbrace{[ \begin{matrix}0 & 0 \\ 0 & 0\end{matrix} ]}}_{{A}_{{C}_{vsc}}} [ \begin{matrix}{Δγ}_{d} \\ {Δγ}_{q}\end{matrix} ] + {\underbrace{[ \begin{matrix}1 & 0 \\ 0 & 1\end{matrix} ]}}_{B {1}_{{C}_{vsc}}} [ \begin{matrix}Δ {i}_{id}^{*} \\ Δ {i}_{iq}^{*}\end{matrix} ] + {\underbrace{[ \begin{matrix}- 1 & 0 \\ 0 & - 1\end{matrix} ]}}_{B {2}_{{C}_{vsc}}} [ \begin{matrix}Δ {i}_{id} \\ Δ {i}_{iq}\end{matrix} ] \qquad ( 9 )$$

$$[ \begin{matrix}Δ {v}_{id} \\ Δ {v}_{iq}\end{matrix} ] = {\underbrace{[ \begin{matrix}{K}_{ic} & 0 \\ 0 & {K}_{ic}\end{matrix} ]}}_{{C}_{{C}_{vsc}}} [ \begin{matrix}{Δγ}_{d} \\ {Δγ}_{q}\end{matrix} ] + {\underbrace{[ \begin{matrix}α {K}_{pc} & 0 \\ 0 & α {K}_{pc}\end{matrix} ]}}_{D {1}_{{C}_{vsc}}} [ \begin{matrix}Δ {i}_{i d}^{*} \\ Δ {i}_{i q}^{*}\end{matrix} ] + {\underbrace{[ \begin{matrix}- {K}_{pc} & - {ω}_{n} {L}_{i} \\ {ω}_{n} {L}_{i} & - {K}_{pc}\end{matrix} ]}}_{D {2}_{{C}_{vsc}}} [ \begin{matrix}Δ {i}_{i d} \\ Δ {i}_{i q}\end{matrix} ] + {\underbrace{[ \begin{matrix}{F}_{V} & 0 \\ 0 & {F}_{V}\end{matrix} ]}}_{D {3}_{{C}_{vsc}}} [ \begin{matrix}Δ {v}_{c d} \\ Δ {v}_{cq}\end{matrix} ] \qquad ( 10 )$$

Where \dot{γ}_{dq} is the error between the measured VSC output current i_{idq} and the reference VSC output current i*_{idq} the d-q reference frame. The d-q components of the output capacitor voltage and VSC output voltage are v_{cdq} and v_{idq}, respectively. This current controller compares i*_{idq} with i_{idq} to generate v_{idq}. F_{V} is the feed-forward control gain of the output capacitor voltage v_{cdq}. Lᵢ models the VSC-side inductance of the LCL filter. The proportional and integral coefficients of the current controller are K_{pc} and K_{ic}, respectively.

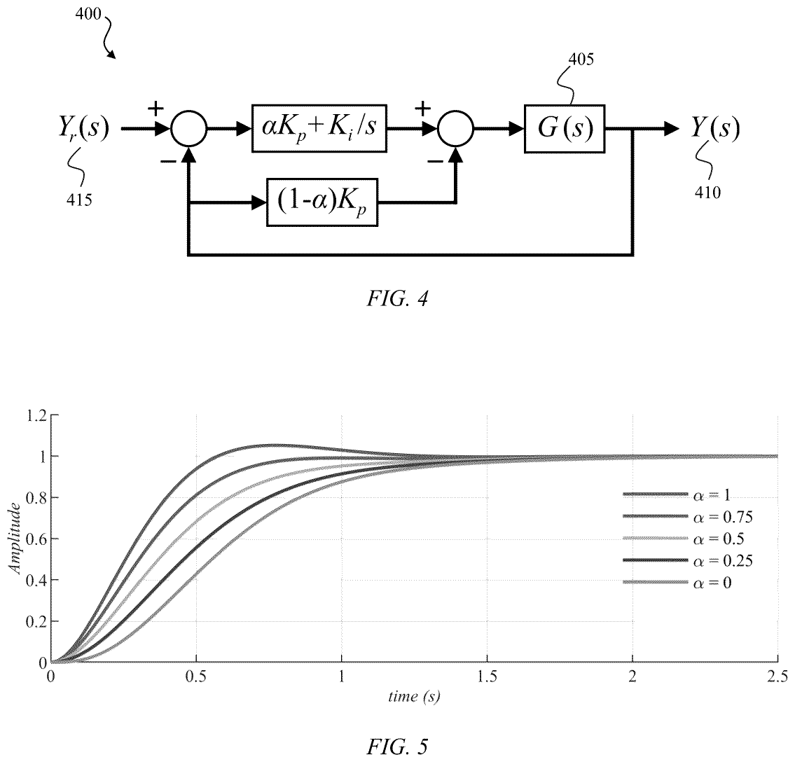

Consider a plant G(s)=N(s)/D(s) 405 in the block diagram 400 shown in FIG. 4, where both IP and PI controllers are incorporated through a blending factor α∈[0,1]. The closed-loop transfer function between the output Y(s) 410 and reference input Yᵣ(s) 415 is:

$$\frac{Y ( s )}{{Y}_{r} ( s )} = \frac{( α {K}_{p} s + {K}_{i} ) N ( s )}{sD ( s ) + ( {K}_{p} s + {K}_{i} ) N ( s )} \qquad ( 11 )$$

The step response of (11) shown in FIG. 5 for Kₚ=30 and Kᵢ=80, illustrates a larger overshoot with PI (α=1) control and a slower response with IP (α=0) control when working alone. The PI controller, by introducing zeros, causes the overshoot. The overshoot can be eliminated by an IP controller that does not introduce zeros. For fixed pole locations, the closer the zeros are to the origin of the complex plane, the larger the effect on dynamic performance related to overshoot. The feedback of (1−α)Kₚ provides an active damping like term that improves the stability of the system. Combining both controllers through an appropriately selected blending factor (e.g., α=0.75) aids in moving the controller zeros further to the left of the complex plane thereby minimizing overshoot and also aids in moving system poles to more convenient locations for a desired response through matrices D1_{V}_{_{VSC}} and D2_{C}_{_{VSC}}. In a similar manner to PI controllers with setpoint weighting, the blended IPPI controllers offer a much better solution than traditional methods of de-tuning the PI controller. The inventive concept illustrates the blended IPPI controllers, albeit similar to PI controllers with setpoint weighting, as newly applied to VSCs and aided by a proposed optimization framework for a desirable system performance.

Small-signal state-space models are developed from the linearization of mathematical equations describing system dynamics, around stable operating points. In the investigated VSC-MG, this is inclusive of state-space models for both VSC and boost converter subsystems, and interconnected lines and loads. Dead-time effect, and the effect of the digital controller's time delay, are also incorporated. The graphical modeling approach is adopted in the small-signal state-space modeling of the VSC-MG.

The state-space model of the power controller is as shown in (12)-(13), where p and q are instantaneous active and reactive outputs of the VSC with low-pass filtered steady-state values P and Q, respectively. The filter's cutoff frequency is ω_{cpc}. V_{ndq} is the nominal voltage operating point in the d-q reference frame. The difference in phase angle between a common reference frame rotating ω_{gcom} and an individual VSC's reference frame is S. Droop gains are set by mₚ (in rad/s/W) and n_{q} (in V/Var) for active and reactive power, respectively. The d-q components of the injected grid current and output capacitor voltage are i_{gdq} and v, with corresponding steady-state values I_{gdq} and V_{cdq}, respectively. In the individual VSC, the droop-governed frequency is ω_{g}, whereas the droop-governed command output capacitor voltage is v^{c}_{cdg}.

$$[ \begin{matrix}Δ \dot{δ} \\ Δ \dot{P} \\ Δ \dot{Q}\end{matrix} ] = {\underbrace{[ \begin{matrix}0 & - {m}_{p} & 0 \\ 0 & - {ω}_{cpc} & 0 \\ 0 & 0 & - {ω}_{cpc}\end{matrix} ]}}_{{A}_{{p}_{vsc}}} [ \begin{matrix}Δδ \\ Δ P \\ Δ Q\end{matrix} ] + {\underbrace{[ \begin{matrix}- 1 \\ 0 \\ 0\end{matrix} ]}}_{B {2}_{{p}_{vsc}}} [ {Δω}_{gcom} ] + \frac{3}{2} {ω}_{cpc} {\underbrace{[ \begin{matrix}0 & 0 & 0 & 0 \\ {I}_{gd} & {I}_{gq} & {V}_{c d} & {V}_{c q} \\ - {I}_{gq} & {I}_{gd} & {V}_{c q} & - {V}_{c d}\end{matrix} ]}}_{B {1}_{{p}_{vsc}}} [ \begin{matrix}Δ {v}_{c d} \\ Δ {v}_{c q} \\ Δ {i}_{gd} \\ Δ {i}_{gq}\end{matrix} ] \qquad ( 12 )$$

$$[ \begin{matrix}{Δω}_{g} \\ Δ {v}_{c d}^{c} \\ Δ {v}_{c q}^{c}\end{matrix} ] = {\underbrace{[ \begin{matrix}0 & - {m}_{p} & 0 \\ 0 & 0 & - {n}_{q} \\ 0 & 0 & 0\end{matrix} ]}}_{{C}_{{p}_{vsc}}} [ \begin{matrix}Δδ \\ Δ P \\ Δ Q\end{matrix} ] \qquad ( 13 )$$

The state-space model of the LCL filter incorporating dead-time effect with continuous space vector pulse width modulation (SVPWM) is as shown in (15)-(18), where k_{d} in (17) is:

$${k}_{d} = \frac{1}{{L}_{i}} \frac{{T}_{d}}{{T}_{sw}} \frac{2 \sqrt{6}}{π} \frac{1}{{( {I}_{id}^{2} + {I}_{iq}^{2} )}^{3 / 2}} \qquad ( 14 )$$

where i_{idq}, i_{gdq}, v_{idq}, and v_{cdq} remain as previously described. Their corresponding steady-state values are I_{idq}, I_{gdq}, V_{idq}, and V_{cdq}, respectively. The switching period and dead-time are T_{sw}(=1/f_{sw}) and T_{d}, respectively. The d-q components of the VSC's grid-bus voltage at the PCC and its corresponding steady-state value are v_{gdq} and v_{gdq}, respectively. The output voltage of the associated boost converter and its corresponding steady-state value are v_{dc}^{out} and V_{dc}^{out}, respectively. The LCL filter parameters R_{g} and L_{g}, C_{f} and R_{f}, and Lᵢ and Rᵢ model the grid-bus-side inductance, filter capacitance, and VSC-side inductance, respectively.

$$[ x \text{?} ] = A \text{?} = [ Δ x \text{?} ] + B 1 \text{?} [ \begin{matrix}Δ {v}_{gd} \\ Δ {v}_{gq}\end{matrix} ] + B 3 \text{?} [ {Δω}_{g} ] \qquad ( 15 )$$

$$\begin{matrix}[ x \text{?} ] = [ \begin{matrix}Δ {i}_{id}^{′} & Δ {i}_{iq}^{′} & Δ {i}_{gd}^{′} & Δ {i}_{gq}^{′} & Δ {v}_{c d}^{′} & Δ {v}_{c q}^{′}\end{matrix} ] , & [ x \text{?} ] = [ \begin{matrix}Δ {i}_{id} & Δ {i}_{iq} & Δ {i}_{gd} & Δ {i}_{gq} & Δ {v}_{c d} & Δ {v}_{c q}\end{matrix} ]\end{matrix} \qquad ( 16 )$$

$${\underbrace{[ \begin{matrix}- \frac{{R}_{i}}{{L}_{i}} - {k}_{d} {I}_{iq}^{2} {V}_{d c}^{out} & {ω}_{n} + {k}_{d} {I}_{id} {I}_{iq} {V}_{d c}^{out} & 0 & 0 & - \frac{1}{L \text{?}} & 0 \\ - {ω}_{n} + {k}_{d} {I}_{id} {I}_{iq} {V}_{d c}^{out} & - \frac{{R}_{i}}{L \text{?}} - {k}_{d} {I}_{iq}^{2} {V}_{d c}^{out} & 0 & 0 & 0 & - \frac{1}{{L}_{i}} \\ 0 & 0 & - \frac{R \text{?}}{L \text{?}} & {ω}_{n} & \frac{1}{L \text{?}} & 0 \\ 0 & 0 & - {ω}_{n} & - \frac{{R}_{i}}{{L}_{i}} & 0 & \frac{1}{L \text{?}} \\ \frac{1}{{C}_{f}} - \frac{{R}_{f} {R}_{i}}{L \text{?}} - {R}_{f} {k}_{d} {I}_{iq}^{2} {V}_{d c}^{out} & {R}_{f} {k}_{d} {I}_{id} {I}_{iq} {V}_{d c}^{out} & \frac{{R}_{f} R \text{?}}{L \text{?}} - \frac{1}{{C}_{f}} & 0 & - \frac{{R}_{f}}{L \text{?}} - \frac{{R}_{f}}{L \text{?}} & {ω}_{n} \\ {R}_{f} {k}_{d} {I}_{id} {I}_{iq} {V}_{d c}^{out} & \frac{1}{{C}_{f}} - \frac{{R}_{f} {R}_{i}}{{L}_{i}} - {R}_{f} {k}_{d} {I}_{iq}^{2} {V}_{d c}^{out} & 0 & \frac{{R}_{f} R \text{?}}{L \text{?}} - \frac{1}{{C}_{f}} & - {ω}_{n} & - \frac{{R}_{f}}{{L}_{i}} - \frac{{R}_{f}}{L \text{?}}\end{matrix} ]}}_{A \text{?}} \qquad ( 17 )$$

$${\underbrace{{[ \begin{matrix}\frac{1}{{L}_{i}} & 0 & 0 & 0 & \frac{{R}_{f}}{{L}_{i}} & 0 \\ 0 & \frac{1}{{L}_{i}} & 0 & 0 & 0 & \frac{{R}_{f}}{{L}_{i}}\end{matrix} ]}^{T}}}_{B 1 \text{?}} , {\underbrace{{[ \begin{matrix}0 & 0 & - \frac{1}{{L}_{g}} & 0 & \frac{{R}_{f}}{{L}_{g}} & 0 \\ 0 & 0 & 0 & - \frac{1}{{L}_{g}} & 0 & \frac{{R}_{f}}{{L}_{g}}\end{matrix} ]}^{T}}}_{B 2 \text{?}} , {\underbrace{{[ \begin{matrix}{I}_{iq} & - {I}_{id} & {I}_{gq} & - {I}_{gd} & {V}_{cq} & - {V}_{c d}\end{matrix} ]}^{T}}}_{B 3 \text{?}} \qquad ( 18 )$$

$$\text{?} \text{indicates text missing or illegible when filed}$$

The state-space model of the virtual impedance block is as shown in (19)-(20), where the virtual inductance and resistance are Lᵥ and Rᵥ, respectively. The d-q components of the injected grid current and its low-pass filtered values are i_{gdq} and i_{gdqf}, respectively, with corresponding steady-state value I_{gdqf}=i_{gdq}. This filter's cut-off frequency is ω_{cvi}. The d-q components of the droop-governed command output capacitor voltage and the reference output capacitor voltage are V_{cdq}^{c} and v_{cdq}*, respectively.

$$[ \begin{matrix}Δ {i}_{gdf}^{*} \\ Δ {i}_{gqf}^{*}\end{matrix} ] = {\underbrace{[ \begin{matrix}- {ω}_{cvi} & 0 \\ 0 & - {ω}_{cvi}\end{matrix} ]}}_{A \text{?}} [ \begin{matrix}Δ {i}_{gdf} \\ Δ {i}_{gqf}\end{matrix} ] + {\underbrace{[ \begin{matrix}{ω}_{cvi} & 0 \\ 0 & {ω}_{cvi}\end{matrix} ]}}_{B \text{?}} [ \begin{matrix}Δ {i}_{gd} \\ Δ {i}_{gq}\end{matrix} ] \qquad ( 19 )$$

$$[ \begin{matrix}Δ {v}_{c d}^{*} \\ Δ {v}_{c q}^{*}\end{matrix} ] = {\underbrace{[ \begin{matrix}- {R}_{v} & {L}_{v} {ω}_{n} \\ {L}_{v} {ω}_{n} & - {R}_{v}\end{matrix} ]}}_{C \text{?}} [ \begin{matrix}Δ {i}_{gdf} \\ Δ {i}_{gqf}\end{matrix} ] + {\underbrace{[ \begin{matrix}1 & 0 \\ 0 & 1\end{matrix} ]}}_{D 1 \text{?}} [ \begin{matrix}Δ {v}_{c d}^{c} \\ Δ {v}_{c q}^{c}\end{matrix} ] + {\underbrace{[ \begin{matrix}{L}_{v} {I}_{gqf} \\ - {L}_{v} {I}_{gdf}\end{matrix} ]}}_{D 2 \text{?}} [ {Δω}_{g} ] \qquad ( 20 )$$

$$\text{?} \text{indicates text missing or illegible when filed}$$

The state-space model of the VSC's DCE, modeling its digital implementation, as shown in (21). This is applied to all input signals (v_{cdq}, i_{idq}, i_{idq}*) to the VSC's current controller. Tₛ is the sampling period delay.

$${G}_{DCE} ( s ) = {e}^{- {sT}_{s}} \frac{1}{{T}_{s}} \frac{1 - {e}^{- {sT}_{s}}}{s} \qquad ( 21 )$$

The reference frame transformation using one of the VSC's synchronous reference frame as the common D-Q reference frame with frequency ω_{g}=ω_{gcom}, in which all other individual VSCs in the network are transformed to is as shown in (22)-(23). In the common D-Q reference frame, the steady-state values of the individual VSC's injected grid current and grid-bus voltage at the PCC are I_{gDQ} and V_{gDQ}, respectively. The phase angle difference between an individual VSC's d-q reference frame and the common D-Q reference frame is δ and its corresponding steady-state value is δ₀.

$$[ \begin{matrix}Δ {i}_{gD} \\ Δ {i}_{gQ}\end{matrix} ] = [ \begin{matrix}cos ( {δ}_{0} ) & - sin ( {δ}_{0} ) \\ sin ( {δ}_{0} ) & cos ( {δ}_{0} )\end{matrix} ] [ \begin{matrix}Δ {i}_{gd} \\ Δ {i}_{gq}\end{matrix} ] + [ \begin{matrix}- {I}_{gd} sin ( {δ}_{0} ) - {I}_{gq} cos ( {δ}_{0} ) \\ {I}_{gd} cos ( {δ}_{0} ) - {I}_{gq} sin ( {δ}_{0} )\end{matrix} ] [ Δ δ ] \qquad ( 22 )$$

$$[ \begin{matrix}Δ {v}_{gd} \\ Δ {v}_{gq}\end{matrix} ] = [ \begin{matrix}cos ( {δ}_{0} ) & sin ( {δ}_{0} ) \\ - sin ( {δ}_{0} ) & cos ( {δ}_{0} )\end{matrix} ] [ \begin{matrix}Δ {v}_{gD} \\ Δ {v}_{gQ}\end{matrix} ] + [ \begin{matrix}- {V}_{gD} sin ( {δ}_{0} ) + {V}_{gQ} cos ( {δ}_{0} ) \\ - {V}_{gD} cos ( {δ}_{0} ) - {V}_{gQ} sin ( {δ}_{0} )\end{matrix} ] [ Δ δ ] \qquad ( 23 )$$

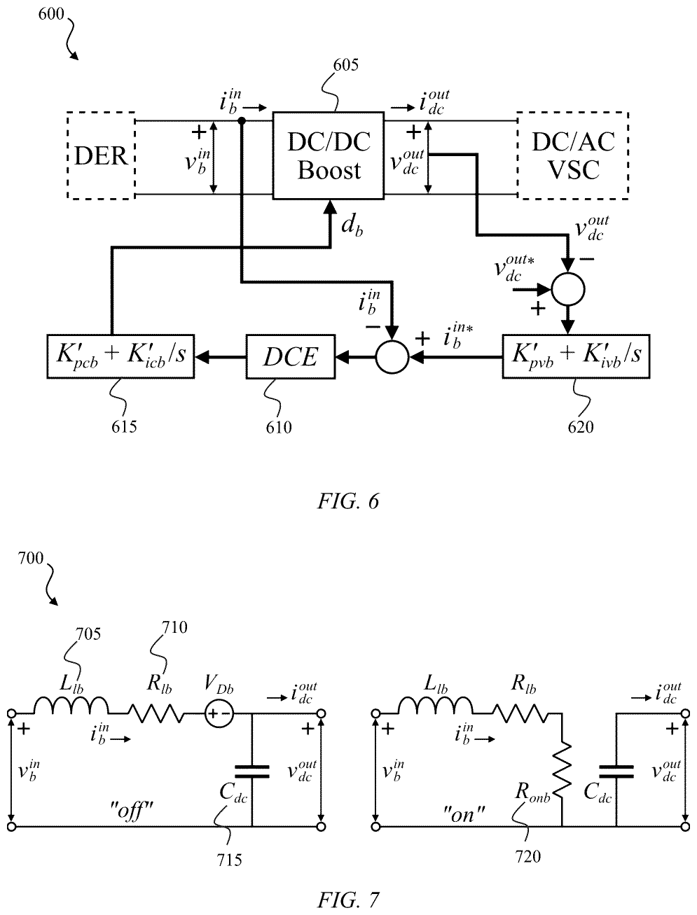

The boost converter subsystem 600 spanning from its input terminals to the input terminals of the VSC subsystem is shown in FIG. 6. Components within this subsystem 600 include the boost converter power model 605, the digital control emulator (DCE) model block 610, and the inner PI current controller 615 and outer PI voltage controller 620.

The state-space model of the PI-based output voltage controller 620 is as shown in (24)-(25), where \dot{ϕ}_{b} is the error between the measured DC-link output voltage v_{dc}^{out} and the reference DC-link output voltage v_{dc}^{out}*. The boost converter's input current reference is i_{b}ⁱⁿ*. This voltage controller compares v_{dc}^{out}* with v_{dc}^{out} to generate i_{b}ⁱⁿ*. The proportional and integral coefficients of the voltage controller are K′_{pvb} and K′_{ivb}, respectively.

$$[ Δ {\dot{ϕ}}_{b} ] = {\underbrace{[ 0 ]}}_{{A}_{Vb}} [ Δ {ϕ}_{b} ] + {\underbrace{[ 1 ]}}_{B {1}_{Vb}} [ Δ {v}_{d c}^{out *} ] + {\underbrace{[ - 1 ]}}_{B {2}_{Vb}} [ Δ {v}_{d c}^{out} ] \qquad ( 24 )$$

$$[ Δ {i}_{b}^{i n *} ] = {\underbrace{[ {K}_{ivb}^{′} ]}}_{{C}_{Vb}} [ Δ {ϕ}_{b} ] + {\underbrace{[ {K}_{pvb}^{′} ]}}_{D {1}_{Vb}} [ Δ {v}_{d c}^{out *} ] + {\underbrace{[ - {K}_{pvb}^{′} ]}}_{D {2}_{Vb}} [ Δ {v}_{d c}^{out} ] \qquad ( 25 )$$

The state-space model of the PI-based inner current controller 615 is as shown in (26)-(27), where \dot{γ}_{b} is the error between the measured input current i_{b}ⁱⁿ and the reference input current i_{b}ⁱⁿ*. The boost converter's duty cycle is d_{b}. This current controller compares i_{b}ⁱⁿ* with i_{b}ⁱⁿ to generate d_{b}. The proportional and integral coefficients of the current controller are K′_{pcb} and K′_{icb}, respectively.

$$[ Δ {\dot{γ}}_{b} ] = {\underbrace{[ 0 ]}}_{{A}_{Cb}} [ Δ {γ}_{b} ] + {\underbrace{[ 1 ]}}_{B {1}_{Cb}} [ Δ {i}_{b}^{i n *} ] + {\underbrace{[ - 1 ]}}_{B {2}_{Cb}} [ Δ {i}_{b}^{i n} ] \qquad ( 26 )$$

$$[ Δ {d}_{b} ] = {\underbrace{[ {K}_{icb}^{′} ]}}_{{C}_{Cb}} [ Δ {γ}_{b} ] + {\underbrace{[ {K}_{pcb}^{′} ]}}_{D {1}_{Cb}} [ Δ {i}_{b}^{i n *} ] + {\underbrace{[ - {K}_{pcb}^{′} ]}}_{D {2}_{Cb}} [ Δ {i}_{b}^{i n} ] \qquad ( 27 )$$

The state-space model of the boost converter power model 700, illustrated in FIG. 7, is as shown in (28)-(29), where R_{lb} 710 and L_{lb} 705 are the internal resistance and inductance of the input filter inductor respectively, C_{dc} 715 is the capacitance of the output DC-link capacitor, and R_{onb} 720 is the resistance of the switching device in its “on-state”. PI-based voltage and current controllers are often used in DC-DC boost converters in comparison with advanced control methods. Moreover, some dominant modes in an islanded VSC-MG network have been shown to be more sensitive to states belonging to the boost converter's power model and not sensitive to states belonging to its accompanying PI-based voltage and current controllers. Hence requiring the parameters R_{lb}, L_{lb}, and R_{onb} be carefully selected. Consequently, the blending of IP and PI controllers is not considered for the boost converter. The boost converter's duty cycle and the diode's forward voltage drop are d_{b} and V_{Db} respectively. The input and output currents are i_{b}ⁱⁿ and i_{dc}^{out}, whereas the input and output voltages are v_{b}ⁱⁿ and v_{dc}^{out}. The steady-state values of the input current, the output voltage, and the duty cycle of the boost converter are I_{b}ⁱⁿ, V_{dc}^{out} and D_{b} respectively.

$$[ \begin{matrix}Δ {i}_{b}^{i n} \\ Δ {v}_{d c}^{out}\end{matrix} ] = {\underbrace{[ \begin{matrix}\frac{- R \text{?} - {D}_{b} R \text{?}}{L \text{?}} & \frac{- 1 + {D}_{b}}{L \text{?}} \\ \frac{1 - {D}_{b}}{{C}_{d c}} & 0\end{matrix} ]}}_{{A}_{Pb}} [ \begin{matrix}Δ {i}_{b}^{i n} \\ Δ {v}_{d c}^{out}\end{matrix} ] + {\underbrace{[ \begin{matrix}\frac{1}{L \text{?}} \\ 0\end{matrix} ]}}_{B {1}_{Pb}} [ Δ {v}_{b}^{i n} ] + {\underbrace{[ \begin{matrix}\frac{{V}_{d c}^{out} + {V}_{Db} - R \text{?} {I}_{b}^{i n}}{L \text{?}} \\ - \frac{{I}_{b}^{i n}}{{C}_{d c}}\end{matrix} ]}}_{B {2}_{Pb}} [ Δ {d}_{b} ] + {\underbrace{[ \begin{matrix}0 \\ - \frac{1}{{C}_{d c}}\end{matrix} ]}}_{B {3}_{Pb}} [ Δ {i}_{d c}^{out} ] \qquad ( 28 )$$

$$[ \begin{matrix}Δ {i}_{b}^{i n} \\ Δ {v}_{d c}^{out}\end{matrix} ] = {\underbrace{[ \begin{matrix}1 & 0 \\ 0 & 1\end{matrix} ]}}_{{C}_{Pb}} [ \begin{matrix}Δ {i}_{b}^{i n} \\ Δ {v}_{d c}^{out}\end{matrix} ] + {\underbrace{[ \begin{matrix}0 & 0 & 0 \\ 0 & 0 & 0\end{matrix} ]}}_{{D}_{Pb}} [ \begin{matrix}Δ {v}_{b}^{i n} \\ Δ {d}_{b}\end{matrix} ] \qquad ( 29 )$$

$$\text{?} \text{indicates text missing or illegible when filed}$$

The DCE is applied and approximated in a similar way as with the VSC subsystem to all input signals (i_{b}ⁱⁿ and i_{b}ⁱⁿ*) to the boost converter's current controller.

The state-space model linking both VSC, and boost converter subsystems is as shown in (30)-(31), where v_{idq} and v_{dc}^{out} are linked through the d-q components of the VSC's duty cycle d_{dq}, with corresponding steady-state value D_{dq}, whereas i_{dc}^{out} and i_{idq} are linked through the power balance principle equating the VSC's output active power to the active power in the DC-link.

$$[ \begin{matrix}Δ {v}_{id} \\ Δ {v}_{iq}\end{matrix} ] = {\underbrace{[ \begin{matrix}{D}_{d} \\ {D}_{q}\end{matrix} ]}}_{{C}_{Vlink}} [ Δ {v}_{d c}^{out} ] + {\underbrace{[ \begin{matrix}{V}_{d c}^{out} & 0 \\ 0 & {V}_{d c}^{out}\end{matrix} ]}}_{{D}_{Vlink}} [ \begin{matrix}Δ {d}_{d} \\ Δ {d}_{q}\end{matrix} ] \qquad ( 30 )$$

$$[ Δ {i}_{d c}^{out} ] = \frac{3}{2} {\underbrace{[ \begin{matrix}{D}_{d} & {D}_{q}\end{matrix} ]}}_{{C}_{Clink}} [ \begin{matrix}Δ {i}_{id} \\ Δ {i}_{iq}\end{matrix} ] + \frac{3}{2} {\underbrace{[ \begin{matrix}{I}_{id} & {I}_{iq}\end{matrix} ]}}_{{D}_{Clink}} [ \begin{matrix}Δ {d}_{d} \\ Δ {d}_{q}\end{matrix} ] \qquad ( 31 )$$

The complete VSG-MG network state-space model is as shown in (33), and is as a result of introducing a virtual resistor R_{N} as shown in (32) through matrices M_{VSC}, M_{LN}, and M_{LD}, mapping the VSCs, lines, and loads respectively to each bus in the network. The state-space model of all interconnecting lines and loads in the VSC-MG network are [i_{LNDQ}] and [i_{LDDQ}], respectively.

$$[ Δ {v}_{gD Q} ] = {R}_{N} ( {M}_{VSC} [ Δ {i}_{gDQ} ] + {M}_{L N} [ Δ {i}_{L NDQ} ] + {M}_{L D} [ Δ {i}_{L DDQ} ] ) \qquad ( 32 )$$

$$[ \begin{matrix}\dot{Δ {x}_{BCVSC}} \\ \dot{Δ {i}_{LNDQ}} \\ \dot{Δ {i}_{LDDQ}}\end{matrix} ] = {A}_{MG} [ \begin{matrix}Δ {x}_{BCVSC} \\ Δ {i}_{LNDQ} \\ Δ {i}_{LDDQ}\end{matrix} ] \qquad ( 33 )$$

The lines, loads, and VSC and boost converter subsystems are combined using a graphical modeling approach to construct the complete system state matrix A_{MG}. For the ith DG, the state vector x_{BCVSC} containing all associated states in the VSC and boost converter subsystems is as shown in (34).

$$Δ {x}_{BCVSCi} = {Δ [ {ϕ}_{bi} {γ}_{bi} {i}_{bi}^{i n} {v}_{dci}^{out} {δ}_{i} {P}_{i} {Q}_{i} {i}_{gdqfi} {ϕ}_{dqi} {γ}_{dqi} {i}_{idqi} {i}_{gdqi} {v}_{cdqi} ]}^{T} \qquad ( 34 )$$

Particle swarm optimization (PSO) forms the basis to which an optimization framework is developed due to its convergence capability and simplicity of tuning parameters. Inspired by the swarm intelligence concept, it has an easy implementation and an effective memory capability. Particles in the swarm are subject to velocities within the search space using the swarm's best experience and its own best knowledge as shown in (35)-(37), where k, i, and N are the iteration index, the particle, and the total number of iterations set to 50, respectively. The total number of particles in the swarm pₛ is set to 5. At iteration k, the inertia weight w^{k} decreases linearly from wₘₐₓ to wₘᵢₙ with settings 0.9 to 0.4 respectively, whereas the velocity and position vectors for each particle i are Vᵢ^{k} and Xᵢ^{k}, respectively. The constants c₁, c₂ are positive numbers set to 2, and r₁ and r₂ are two uniformly distributed random numbers in the range [0,1]. The second and third components in (36) scaled by c₁r₁ and c₂r₂ represent the “self-knowledge” and “group-knowledge” components of each particle, respectively. During the iterative process, the best positions each particle i has attained based on its own knowledge and the swarm's best experience are Xpbᵢ^{k} and Xsb^{k}, respectively.

$${w}^{k} = {w}_{max} - ( {m}_{ma x} - {w}_{min} ) \cdot ( ( k - 1 ) / N ) \qquad ( 35 )$$

$${V}_{i}^{k + 1} = {w}^{k} {V}_{i}^{k} + {c}_{1} {r}_{1} ( {Xpb}_{i}^{k} - {X}_{i}^{k} ) + {c}_{2} {r}_{2} ( {Xsb}^{k} - {X}_{i}^{k} ) \qquad ( 36 )$$

$${X}_{i}^{k + 1} = {X}_{i}^{k} + {V}_{i}^{k + 1} \qquad ( 37 )$$

This tool is used to obtain an appropriate blending factor in the scenario where PI controllers are unable to preserve stability, by moving the dominant modes in the system to their furthest possible locations from the right half of the complex plane. A mode in the form m_{y}=σ or m_{y}^{x}=σ±jω has a frequency of oscillation f=ω/2π, and damping ratio ζ=−σ/\sqrt{σ²+ω²}. An improved stable overall system performance is attainable when the dominant modes are moved further to the left of the complex plane. The objection function expressed in (38) at its minimum would indicate that all dominant modes in the system are at their furthest possible locations from the right half of the complex plane.

$$\begin{matrix}{min}_{α} & J = {\sum }_{m = 1}^{M} {σ}_{m} & \\ s . t . & 0 \leq {α}_{n} \leq 1 & ( n = 1 , 2 , … , N ) , \\ & {σ}_{0} \leq {σ}_{m} \leq 0 & ( m = 1 , 2 , … , M ) , \\ & {ζ}_{0} \leq {ζ}_{m} & \end{matrix} \qquad ( 38 )$$

Where αₙ represents the blending factors of the IPPI controllers for the nth VSC. The conditions σ₀≤σₘ≤0 and ζ₀≤ζₘ are imposed simultaneously to have some degree of relative stability and limit the maximum overshoot respectively, where M is the number of modes σₘ and ζₘ are the real part and damping ratios of the mth mode respectively, and σ₀ and ζ₀ are the corresponding desirable performance metrics. To facilitate the convergence of the swarm, the conditions in (39) and (40) are performed at every iteration after each particle's velocity and position are updated.

$$\begin{matrix}{X}_{i , j}^{m ax} = max [ {X}_{i , j} ] , {X}_{i , j}^{m i n} = min [ {X}_{i , j} ] \\ if {X}_{i , j}^{k} > {X}_{i , j}^{max} , then {X}_{i , j}^{k} = {X}_{i , j}^{max} \\ else if {X}_{i , j}^{k} < {X}_{i , j}^{m i n} , then {X}_{i , j}^{k} = {X}_{i , j}^{m i n}\end{matrix} \qquad ( 39 )$$

$$\begin{matrix}{V}_{i , j}^{ma x} = 0.2 ( {X}_{i , j}^{ma x} - {X}_{i , j}^{m i n} ) , {V}_{i , j}^{m i n} = - {V}_{i , j}^{ma x} \\ if {V}_{i , j}^{k} > {V}_{i , j}^{max} , then {V}_{i , j}^{k} = {V}_{i , j}^{max} \\ else if {V}_{i , j}^{k} < {V}_{i , j}^{m i n} , then {V}_{i , j}^{k} = {V}_{i , j}^{m i n}\end{matrix} \qquad ( 40 )$$

Where X_{i,j}^{max} and X_{i,j}^{min} are the upper and lower limits with regards to the domain of stability for the jth element of the ith particle's position X_{i,j}, whereas V_{i,j}^{max} and V_{i,j}^{min} are the upper and lower limits with regards to the jth element of the ith particle's velocity V_{i,j}. The following steps describe the complete optimization framework using PSO.
1) Initialization:
   1.1 In the swarm of size p₃, randomly select each particle's position X_{i,j} within the domain of stability.
   1.2 Initialize each particle's velocity V_{i,j} to 0.
   1.3 Evaluate overall system modes for each particle.
   1.4 Evaluate J using (38) for each particle. Xpbᵢ is initialized with a copy of Xᵢ, whereas Xsb is initialized with a copy of Xᵢ having the best J.
2) Iteration & Weight Update: With k starting at 1, update the iteration index. Update the inertia weight using (35).
3) Velocity Update: Update each particle's velocity using (36). Then apply (40) to ensure all velocities are within predefined limits.
4) Position Update: With the updated velocities, each particle's position is updated using (37). Then apply (39) to ensure all positions are within predefined limits.
5) Objective Function Evaluation: For each particle, evaluate overall system modes. Then evaluate J using (38).
6) Particle Best Update: For each particle, if the evaluated J in current iteration is better than the evaluated J's in previous iterations, then update Xpbᵢ with a copy of Xᵢ.
7) Swarm Best Update: In current iteration, update X_{sb} with a copy of Xpbᵢ having the best J.
8) Stopping Criteria: Repeat steps 2 to 7 until one of the following conditions is met:
   8.1 The evaluated J has not improved for a predefined number of iterations.
   8.2 The maximum number of iterations N is reached.

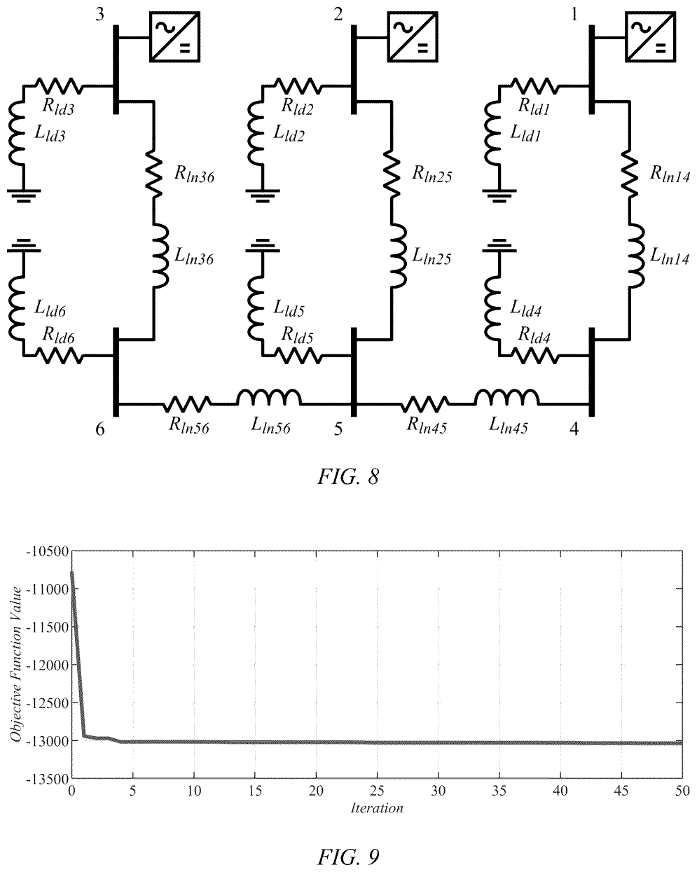

An islanded 50 Hz, 230 V VSC-MG network shown in FIG. 8 consists of DGs represented in a two-stage power conversion structure comprised of VSC and boost converter subsystems. Table 1 and Table 2 show the parameters and steady-state initial operating conditions respectively in the MG network. DGs in the network are rated at 100 kVA. With the aid of MATLAB/Simulink R2018b, stability is assessed using the small-signal state-space models as previously described.

TABLE 1
VSC, boost converter, and network model parameters.

| Par. | Value | | Par. | Value | | Par. | Value | |
|---|---|---|---|---|---|---|---|---|
| Vₙ | 230 | V | f_{sw} | 10 | kHz | T_{d} | 2 | μs |
| ωₙ, ω_{g} | 100π | rad/s | Tₛ | 50 | μs | ω_{cpc}, | 20π | rad/s |
| | | | | | | ω_{cvi} | | |
| Lᵢ | 350.45 | μH | C_{f} | 70 | μF | L_{g} | 34 | μH |
| Rᵢ | 30 | mΩ | R_{f} | 2.1 | Ω | R_{g} | 1 | mΩ |
| mₚ | π × 10⁻⁶ | | n_{q} | 9 × 10⁻⁴ | | R_{N} | 10 | kΩ |
| Kₚᵥ | 0.2475 | | Kᵢᵥ | 437.5 | | V_{b}ⁱⁿ | 540 | V |
| K_{pc} | 3.0583 | | K_{ic} | 2668.8 | | V_{Db} | 1.1 | V |
| R_{lb} | 1 | mΩ | L_{lb} | 300 | μH | C_{dc} | 10 | mF |

| | | | | | | |
|---|---|---|---|---|---|---|
| R_{onb} | 2 | mΩ | F_{V} | 1 | F_{C} | 1 |

| | | | | | |
|---|---|---|---|---|---|
| Z_{ld5} | (1.6 + | K′_{pcb} | 0.0034 | K′_{icb} | 8.8188 |
| | j0.5024) Ω | | | | |
| Z_{ld6} | (1.6 + | K′_{pvb} | 4.6265 | K′_{ivb} | 606.0489 |
| | j0.5024) Ω | | | | |
| Z_{ld1} | (7 + | Z_{ld2} | (14 + | Z_{ld3} | (4.85 + |
| | j2.198) Ω | | j4.396) Ω | | j1.4444) Ω |
| Z_{ld4} | (2.4 + | Zₗₙ₁₄ | (0.1162 + | Zₗₙ₂₅ | (0.1356 + |
| | j0.7536) Ω | | j0.0233) Ω | | j0.0271) Ω |
| Zₗₙ₃₆ | (0.0969 + | Zₗₙ₄₅ | (0.0193 + | Zₗₙ₅₆ | (0.0231 + |
| | j0.0194) Ω | | j0.0091) Ω | | j0.011) Ω |
| Z_{v, VSC1} | (19.6 + | Z_{v, VSC2} | (0 + | Z_{v, VSC3} | (38.7 + |
| | j3.9) mΩ | | j0) mΩ | | j7.8) mΩ |

TABLE 2
Steady-State Initial Operating Conditions

| Par. | Value | Par. | Value |
|---|---|---|---|
| δ₀₁ | 0 rad | V_{cd1}, V_{cd2}, V_{cd3} | [299, 304, 294] V |
| δ₀₂ | −3.6 × 10⁻⁴ rad | V_{cq1}, V_{cq2}, V_{cq3} | [0.4, 0, 0.9] V |
| δ₀₃ | −2.99 × 10⁻³ rad | I_{id1}, I_{id2}, I_{id3} | [180, 177, 184] A |
| V_{gD1}, V_{gD2}, V_{gD3} | [298, 303, 293] V | I_{iq1}, I_{iq2}, I_{iq3} | −[46, 44, 51] A |
| V_{gQ1}, V_{gQ2}, V_{gQ3} | −[1.5, 1.8, 1] V | I_{gd1}, I_{gd2}, I_{gd3} | [179, 177, 183] A |
| V_{dc1}^{out}, V_{dc2}^{out}, V_{dc3}^{out} | [800] V | I_{gq1}, I_{gq2}, I_{gq3} | −[55, 53, 60] A |
| I_{b1}ⁱⁿ, I_{b2}ⁱⁿ, I_{b3}ⁱⁿ | [152, 152, 153] A | D_{b1}, D_{b2}, D_{b3} | [0.326] |
| D_{d1}, D_{d2}, D_{d3} | [0.39, 0.39, 0.38] | D_{q1}, D_{q2}, D_{q3} | [0.02] |
| P₁, Q₁ | [80.37, 24.88] kVA | P₂, Q₂ | [80.47, 24.06] kVA |
| P₃, Q₃ | [80.69, 26.78] kVA | I_{ldD1}, I_{ldQ1} | [38.7, −12.4] A |
| I_{InD14}, I_{InQ14} | [140.5, −42.8] A | I_{ldD2}, I_{ldQ2} | [19.7, −6.3] A |
| I_{InD25}, I_{InQ25} | [157.1, −46.5] A | I_{ldD3}, I_{ldQ3} | [55.3, −16.9] A |
| I_{InD36}, I_{InQ36} | [128, −43.4] A | I_{ldD4}, I_{ldQ4} | [106.6, −33.4] A |
| I_{InD45}, I_{InQ45} | [33.9, −9.5] A | I_{ldD5}, I_{ldQ5} | [159.5, −50] A |
| I_{InD56}, I_{InQ56} | [31, −6.6] A | I_{ldD6}, I_{ldQ6} | [159, −50] A |

The complete state-space model of the VSC-MG network in FIG. 8 has a total of 245 states, and the DG's VSC at bus 1 is selected as the common reference frame to which other VSCs are transformed to. For the blended IPPI voltage and current controllers previously described, if α=1, the controllers become PI controllers, whereas if α=0 the controllers become IP controllers. Table 3 shows certain eigenvalues (modes) of interest due to the proximity of their trajectories to the right half of the complex plane as a changes. This table compares the conventional PI-based controllers with the blended IPPI controllers as a changes. The closer a mode is to the right half of the complex plane, the larger its contribution towards the overall system performance. These modes are therefore considered the dominant modes in the system. An unstable mode m₁₄¹³ exists for α=1 and α=0.6, and would result in an unstable overall system performance. Not shown in the table are α<0.6, where the system remains unstable due to modes m₁₄¹³ and m₁₆¹⁵ as they move further into the right half of the complex plane. The other modes either remain fairly stationary or move further towards the right of the complex plane as α decreases from 0.9. This interference therefore demonstrates the need to select an appropriate blending factor α, that ensures modes that can impact stability are at their furthest possible locations from the right half of the complex plane. This provides an added flexibility in the scenario where conventional PI-based controllers (i.e. α=1), are unable to ensure a stable overall system performance.

TABLE 3
Mode Analysis at Different Blending Factors

| m₀ | α = 1 | α = 0.9 | α = 0.8 | α = 0.7 | α = 0.6 |
|---|---|---|---|---|---|
| m₁ | −4.29 | −4.29 | −4.29 | −4.29 | −4.29 |
| m₂ | −5.38 | −5.38 | −5.38 | −5.38 | −5.38 |
| m₃ | −55.61 | −55.62 | −55.64 | −55.66 | −55.68 |
| m₄ | −60.89 | −60.89 | −60.90 | −60.91 | −60.91 |
| m₅ | −62.75 | −62.75 | −62.75 | −62.75 | −62.75 |
| m₆ | −62.80 | −62.80 | −62.80 | −62.80 | −62.80 |
| m₇ | −62.80 | −62.80 | −62.80 | −62.80 | −62.80 |
| m₈ | −64.00 | −64.00 | −64.01 | −64.02 | −64.02 |
| m₉ | −68.65 | −68.67 | −68.69 | −68.71 | −68.73 |
| m₁₀ | −73.65 | −73.69 | −73.72 | −73.76 | −73.79 |
| m₁₁ | −138.49 | −1333.36 | −129.61 | −126.68 | −124.29 |
| m₁₂ | −175.67 | −160.75 | −152.53 | −146.90 | −142.65 |
| m₁₄¹³ | 5.30 ± | −52.26 ± | −26.06 ± | −3.56 ± | 11.47 ± |
| | j706.59 | j509.00 | j400.81 | j343.13 | j305.73 |
| m₁₆¹⁵ | −4.80 ± | −67.43 ± | −42.04 ± | −17.95 ± | −1.29 ± |
| | j726.59 | j529.13 | j415.45 | j354.42 | j315.07 |
| m₁₈¹⁷ | −157.87 ± | −157.88 ± | −157.89 ± | −157.90 ± | −157.90 ± |
| | j130.55 | j130.51 | j130.47 | j130.44 | j130.40 |
| m₂₀¹⁹ | −165.42 ± | −165.41 ± | −164.82 ± | −164.11 ± | −163.44 ± |
| | j134.81 | j132.79 | j131.36 | j130.43 | j129.82 |
| m₂₂²¹ | −167.48 ± | −166.41 ± | −165.19 ± | −164.18 ± | −163.37 ± |
| | j133.60 | j131.25 | j130.03 | j129.37 | j128.98 |
| m₂₄²³ | −212.72 ± | −324.68 ± | −214.97 ± | −162.65 ± | −131.76 ± |
| | j827.90 | j532.30 | j405.41 | j359.89 | j330.70 |
| m₂₆²⁵ | −216.94 ± | −314.84 ± | −205.32 ± | −155.41 ± | −125.79 ± |
| | j809.64 | j506.76 | j392.13 | j348.98 | j320.80 |

In this exemplary embodiment of the present invention, the desired performance metrics α₀ and ζ₀ are chosen to be −1000 and 0.1 respectively. Each particle's position Xᵢ=(α₁, α₂, α₃) contain the parameters to be optimized. Analysis from Table 3 revealed the system is stable for α_{1,2,3} ∈[0.68, 0.99]. Further analysis revealed the domain of stability α_{1,2,3} ∈[0.775, 0.962] satisfied ζₘ≥0.1. Therefore, to satisfy the condition limiting the maximum overshoot in (38) and improve the computational efficiency of the optimization framework, the domain stability α_{1,2,3} ∈[0.88, 0.912] is the updated constraint of the optimization. Following the steps describing the optimization framework using PSO in the previous description, the convergence of the objective function is shown in FIG. 9 and minimized at J=−13036 using (38). The resulting optimized blending factors, (α=opt are α₁=0.90244, α₂=0.89974 and α₃=0.88405). The corresponding locations and damping ratios for the modes of interest are shown in Table 4.

TABLE 4
Mode Locations and Damping Ratios
Using Optimized Blending Factors

| m₀ | α = opt | ζₘ |
|---|---|---|
| m₁ | −4.29 | 1.00 |
| m₂ | −5.38 | 1.00 |
| m₃ | −55.63 | 1.00 |
| m₄ | −60.90 | 1.00 |
| m₅ | −62.75 | 1.00 |
| m₆ | −62.80 | 1.00 |
| m₇ | −62.80 | 1.00 |
| m₈ | −64.01 | 1.00 |
| m₉ | −68.67 | 1.00 |
| m₁₀ | −73.69 | 1.00 |
| m₁₁ | −133.36 | 1.00 |
| m₁₂ | −159.78 | 1.00 |
| m₁₄¹³ | −50.27 ± j493.43 | 0.1013 |
| m₁₆¹⁵ | −67.74 ± j530.82 | 0.1266 |
| m₁₈¹⁷ | −157.88 ± j130.51 | 0.7708 |
| m₂₀¹⁹ | −165.40 ± j132.80 | 0.7798 |
| m₂₂²¹ | −166.29 ± j131.09 | 0.7853 |
| m₂₄²³ | −327.30 ± j535.17 | 0.5217 |
| m₂₆²⁵ | −298.22 ± j483.20 | 0.5252 |

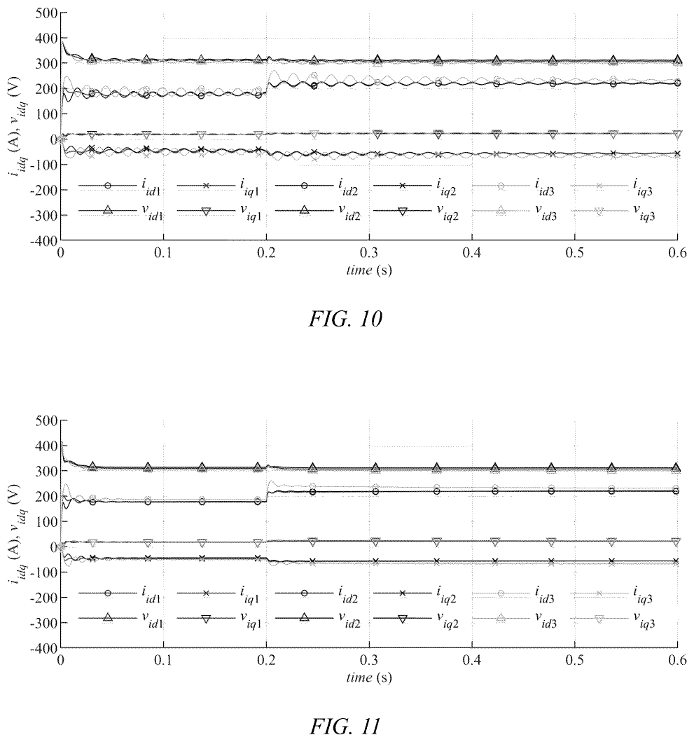

Simulation results presented within include start-up transient behavior and the (doubling) step change in the load at bus 6 at time=0.2 s. The response of the d-q components of the output VSC currents i_{idq} and the output VSC voltages v_{idq} from the DGs is shown in FIG. 10 for α=0.7 and in FIG. 11 for α=opt. The dominant oscillatory mode m₁₄¹³ for α=0.7 (see Table 3) influences system performance due to its proximity to the right half of the complex plane, resulting in a long settling time. The desired dynamic performance is exhibited for α=opt (see Table 4) as the optimized blending factors move the dominant modes in the system to their furthest possible locations from the right half of the complex plane. In FIG. 11, for α=opt, the steady-state values after the change in load are i_{id1,2,3} [220.7, 218.8, 232.0]A, i_{iq 1,2,3} [−56.7, −56.3, −68.1]A, v_{id 1,2,3} [307.2, 311.5, 299.8]V, and i_{id 1,2,3} [23.1, 22.1, 24.3]V.

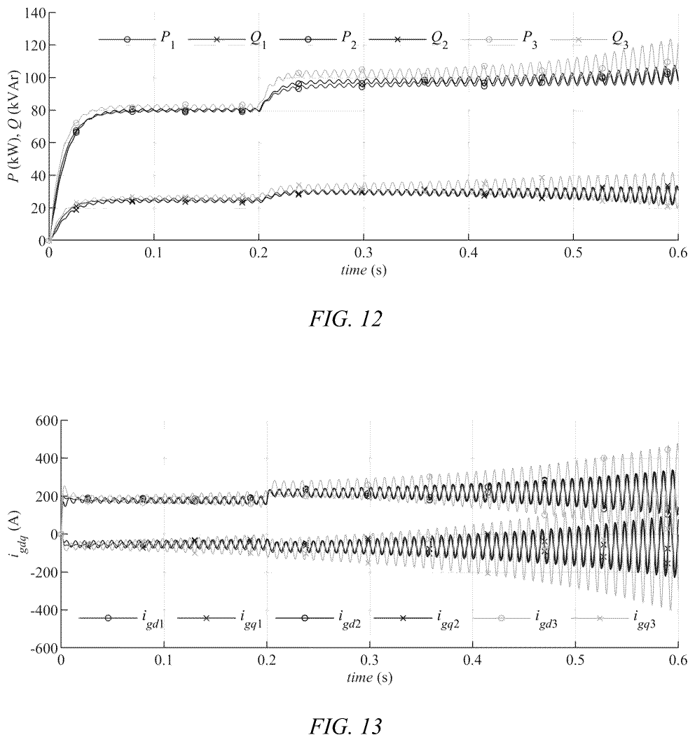

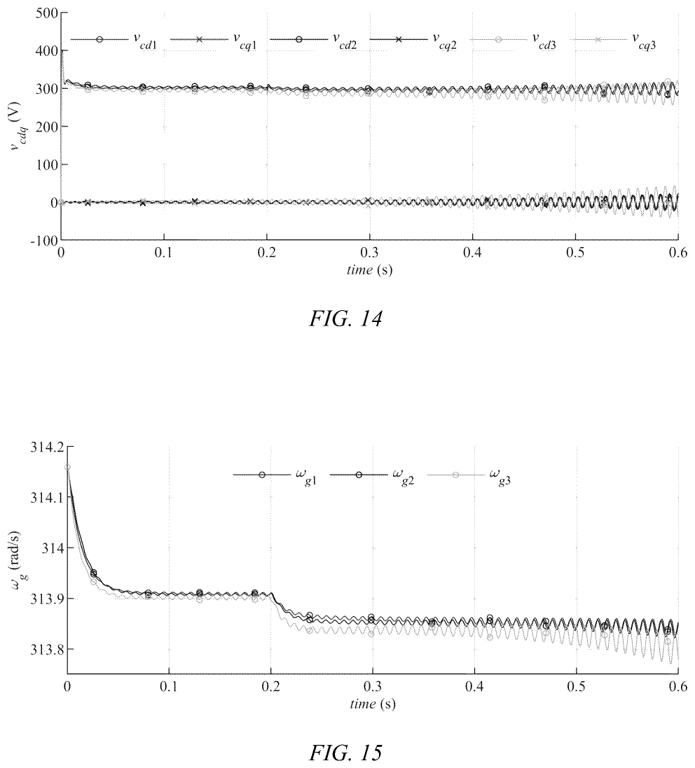

FIGS. 12-15 and FIGS. 16-19 illustrate the dynamic responses at the AC terminal of the VSC subsystem for conventional PI-based controllers (α=1) and optimized blended IPPI controllers (α=opt), respectively. Both scenarios illustrate the added flexibility and a more effective utilization of the VSC-interfaced DGs that is allowed when using blended IPPI voltage and current controllers. In the scenario where α=1 (i.e. conventional PI-based controllers) the system is unstable due to the unstable mode m₁₄¹³ located in the right half of the complex plane (see Table 3). The FIGS. 12, 13, 14 and 15 show responses of the active and reactive power outputs, the d-q components of the injected grid currents i_{gdq}, the d-q components of the output capacitor voltages v_{cdq}, and the droop-governed VSC frequency from the DGs respectively, illustrating the influence of this mode on overall system performance.

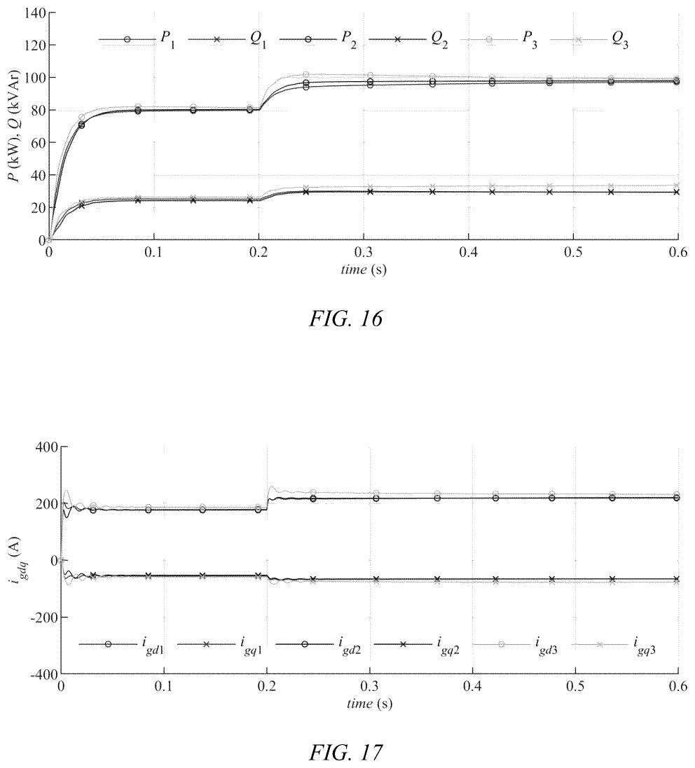

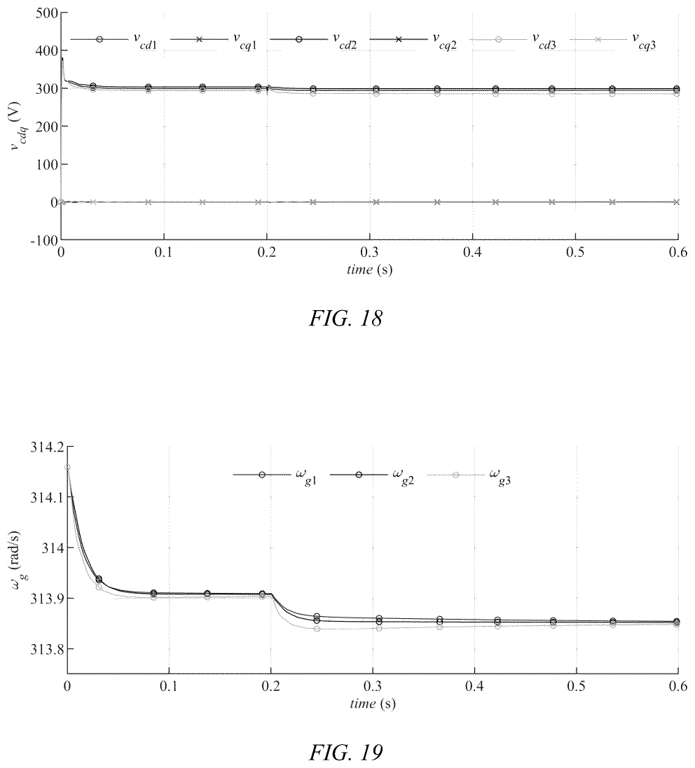

The desired dynamic performance is illustrated in the scenario where α=opt (i.e. optimized blended IPPI controllers) in which the dominant modes in the system are moved to their furthest possible locations from the right half of the complex plane. The response of the active and reactive power outputs from the DGs is shown in FIG. 16. The active (P) and reactive (Q) power loads in the MG network are shared between the DGs based on the droop control characteristics of the VSC's power controller together with its adjacent virtual impedance loop. The response of the DGs to the change in load is linked to its electrical distance from the changed load. The DG at bus 1 responds slower than the DG at bus 3 due to its longer electrical distance from bus 6 where the change in load occurred. The DG at bus 3 responds the fastest and initially provides most of the additional power to meet the change in load. The steady-state values after the change in load are P_{1,2,3} [98.2, 98.6, 98.9] kW and Q_{1,2,3} [29.3, 29.4, 33.6] kVar. The response of the d-q components of the injected grid currents i_{gdq} from the DGs is shown in FIG. 17. The d- and q-components respond in a similar manner to their corresponding active and reactive power outputs from the DGs. The steady-state values after the change in load are i_{gd 1,2,3} [220, 218, 232]A and i_{gq1,2,3} [−66, −66, −78]A. The response of the d-q components of the output capacitor voltages v_{cdq} from the DGs is shown in FIG. 18. An inverse relationship exists between the d-component and the reactive power sharing between the DGs. The steady-state values after the change in load are v_{cd 1,2,3} [294, 299, 285]V and v_{cq 1,2,3} [0.4, 0, 1.2]V. The response of the droop-governed VSC frequency from the DGs is shown in FIG. 19. The larger the active power contribution from a DG during the change in load, the larger the deviation of its droop-governed frequency. The DG at bus 3 therefore has the largest swing compared to the other DGs. The steady-state network frequency after the change in load is 313.85 rad/s.

The blended IPPI-based controllers using the optimized blending factors α=opt obtained, (α₁=0.90244, α₂=0.89974 and α₃=0.88405), are analyzed under three different operating conditions (OCs), and the locations of the dominant modes m₁−m₂₆²⁵ are compared with the conventional PI-based controllers (i.e. α=1) in Table 5. The parameters changed are with respect to base parameters in Table 1. OC 1 is a 10% reduction in network load and hence a reduction in DG power outputs (P_{1,2,3} [74.40, 74.49, 74.69] kW and Q_{1,2,3} [23.01, 22.23, 24.81] kVar). OC 2 uses dissimilar active power droop gains (m_{p1,2,3} [23.01, 22.23, 24.81]×π×10⁶) resulting in different DG power outputs (P_{1,2,3} [88.69, 80.07, 73.00] kW and Q_{1,2,3} [22.28, 24.18, 29.33] kVar). In OC 2, the droop control characteristics shows an increase in active power output for the DG's VSC with the smaller mₚ and a decrease in the active power output for the DG's VSC with the larger mₚ. OC3 uses higher reactive power gains (n_{q1,2,3} [2, 2, 2]×9×10⁴). In OC 3, a consequence of a higher n_{q} is a reduction in the output voltage of the VSCs and hence active and reactive power outputs (P_{1,2,3} [71.41, 71.42, 71.44] kW and Q_{1,2,3} [22.20, 21.81, 23.17] kVar). The takeaway from Table 5 is that the modes m₁₄¹³ and m₁₆¹⁵ contributing to instability in the three different operating conditions when using PI-based control are at new stable locations when using IPPI-based control having appropriately selected blending factors. The optimized blending factors using one operating condition is sufficient for other operating conditions.

In various embodiments of the present invention, small-signal state-space models are developed for blended IPPI-based voltage and current controllers in a VSC to provide an added flexibility in the scenario where the conventional PI-based voltage and current controllers are unable to ensure a stable overall system performance. This translates to a more effective utilization of the VSC-interfaced DGs. To achieve a desirable dynamic performance, an optimization framework is developed utilizing particle swarm optimization to select appropriate blending factors. Within the optimization framework is an objective function proposed to enhance the damping characteristics and preserve stability through the resulting blending factors. Time domain simulations are carried out to illustrate the responses of the DGs to a change in load. The analysis and results confirm the effectiveness of the optimization framework, the adequacy of the objective function, and the desired performance of the optimized blending factors.

The essence of the invention lies in its amalgamation of conventional PI and IP controllers for voltage and current control through a single parameter only, which, when optimized, promises to deliver superior transient response, improved stability margins, and wider operating ranges for VSCs in comparison to conventional standalone PI controllers. This novelty provides an added flexibility in scenarios where PI-based voltage and current controllers are unable to ensure a stable overall system performance across several operating conditions.

More specifically, the present invention combines the desirable attributes of PI-based and IP-based controllers through a blending factor, a. The voltage controller compares the reference and measured output capacitor voltages to generate the VSC output current reference, whereas the current controller compares reference and measured VSC output currents to generate the VSC output voltage. The core technology takes advantage of IP controllers' two degrees-of-freedom (DOF), enabling independent optimization of responses to input commands and system disturbances.

Compared with currently available technologies, the invention possesses the following novelties and contributions: 1) it creates varying 2 DOF MG controllers with plug-and-play capabilities: 2) it exhibits better transient responses and improved stability margins would aid in improving the safety, security, and reliability of power systems especially MGs; 3) it provides wider operating ranges of MGs than the conventional PI-based controllers for hosting RERs such that high capital investments for major reinforcements of power systems can be delayed.

The present invention additionally provides added flexibility in scenarios where PI-based voltage and current controllers are unable to ensure a stable overall system performance across several operating conditions. The embodiments of the present invention are easier and less inexpensive to manufacture than many of the existing PI-based controllers.

The present invention would be of interest to manufacturers of grid interfaced VSCs and controllers, manufacturers of RERs (e.g., wind turbines, photovoltaic arrays, battery energy storage systems) for grid applications, power utility companies planning towards a clean and sustainable energy future, small-scale RERs for residential and industrial needs and researchers developing varying 2 DOF MG controllers with plug-and-play capabilities.

The proposed technology would enable manufacturers to expand the operating ranges of their manufactured energy resources and interfacing VSCs. It would also enable power utilities to manage high capital investments and reshape their planning horizons as an option while maintaining the security and reliability of their electrical infrastructure integrating RERs even as energy demand increases in the long term. Lastly, for small-scale residential and industrial needs, the technology would enable the reliability and security of supply considering the varying nature of energy profiles for both needs.

The likely commercial product would be programmable fabricated device that would be integrated in VSCs. The likely end users are VSC manufacturers, power utility planners, and small-scale residential and industrial entities, A future application may be interdisciplinary in nature, in which control concepts are adopted to control other electrical quantities, such as active and reactive power. There is also an opportunity for similar control concepts to be adopted outside the field of electrical engineering.

The most likely commercialization path is towards manufacturers of grid integrated VSCs and applicable controllers. The technology would be software driven and embedded into a fabricated device with input and output terminals responding to input commands and system disturbances in the VSC-MG.

The present invention may be embodied on various computing platforms that perform actions responsive to software-based instructions and most particularly on touchscreen portable devices. The following provides an antecedent basis for the information technology that may be utilized to enable the invention.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any non-transitory, tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. However, as indicated above, due to circuit statutory subject matter restrictions, claims to this invention as a software product are those embodied in a non-transitory software medium such as a computer hard drive, flash-RAM, optical disk or the like.

Program code embodied on a computer readable medium may be transmitted using any appropriate medium, including but not limited to wireless, wire-line, optical fiber cable, radio frequency, etc., or any suitable combination of the foregoing. Computer program code for carrying out operations for aspects of the present invention may be written in any combination of one or more programming languages, including an object-oriented programming language such as Java, C#, C++, Visual Basic or the like and conventional procedural programming languages, such as the “C” programming language or similar programming languages.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

What is claimed is:

1. A controller for use in a voltage source converter (VSC) subsystem, the controller comprising:
an integral-proportional (PI)/proportional-integral (PI) (IPPI) current controller; and
an IPPI voltage controller, wherein the IPPI current controller and the IPPI voltage controller incorporates both PI and IP control through a blending factor α.

2. The controller of claim 1, wherein the blending factor α is optimized.

3. The controller of claim 1, wherein the blending factor α is optimized to enhance damping characteristics and preserve stability for a desired system performance of the VSC subsystem.

4. The controller of claim 1, wherein the blending factor α is optimized by solving:
$$\begin{matrix}{min}_{α} {\sum }_{m = 1}^{M} {σ}_{m} \\ s . t . \{ \begin{matrix}0 \leq {α}_{n} \leq 1 & ( n = 1 , 2 , … , N ) \\ \begin{matrix}{σ}_{0} \leq {σ}_{m} \leq 0 \\ {ζ}_{0} \leq {ζ}_{m}\end{matrix} & ( m = 1 , 2 , … , M )\end{matrix}\end{matrix}$$
where αₙ represents the blending factor of the IPPI current controller and the IPPI voltage controller for the nth VSC of the VSC subsystem, wherein M is the number of modes, wherein σ₀≤σₘ≤0 and ζ₀≤ζₘ are imposed simultaneously, wherein σₘ and ζₘ are a real part and damping ratios of the mth mode, respectively, wherein σ₀ and ζ₀ are corresponding desirable system performance metrics.

5. The controller of claim 1, wherein solving for the optimized blending factor α utilizes a particle swarm optimization (PSO) technique.

6. The controller of claim 1, wherein the IPPI voltage controller compares a reference output capacitor voltage with a measured output capacitor voltage to generate a VSC output current reference.

7. The controller of claim 6, wherein the IPPI current controller compares the VSC output current reference with a measured VSC output current to generate a VSC output voltage.

8. The IPPI voltage controller of claim 1, wherein the IPPI voltage controller controls a voltage delivered to a micro grid (MG).

9. The IPPI current controller of claim 1, wherein the IPPI current controller controls a current delivered to a micro grid (MG).

10. A voltage source converter (VSC) subsystem, the VSC subsystem comprising:
a DC-AC VSC;
a power controller;
a virtual impedance model block,
an inductor-capacitor-inductor (LCL) filter and dead-time model block;
a digital control emulator (DCE) model block;
an inner integral-proportional (IP)/proportional-integral (PI) (IPPI) current controller; and
an outer IPPI voltage controller, wherein the inner IPPI current controller and the outer IPPI voltage controller incorporates both PI and IP control through a blending factor α.

11. The controller of claim 10, wherein the blending factor α is optimized by solving:
$$\begin{matrix}{min}_{α} {\sum }_{m = 1}^{M} {σ}_{m} \\ s . t . \{ \begin{matrix}0 \leq {α}_{n} \leq 1 & ( n = 1 , 2 , … , N ) \\ \begin{matrix}{σ}_{0} \leq {σ}_{m} \leq 0 \\ {ζ}_{0} \leq {ζ}_{m}\end{matrix} & ( m = 1 , 2 , … , M )\end{matrix}\end{matrix}$$
where αₙ represents the blending factor of the IPPI current controller and the IPPI voltage controller for the nth VSC of the VSC subsystem, wherein M is the number of modes, wherein σ₀≤σₘ≤0 and ζ₀≤ζₘ are imposed simultaneously, wherein σₘ and ζₘ are a real part and damping ratios of the mth mode, respectively, wherein σ₀ and ζ₀ are corresponding desirable system performance metrics.

12. A method for controlling a voltage source converter (VSC), the method comprising:
incorporating a controller into a VSC subsystem, the controller comprising;
an integral-proportional (IP)/proportional-integral (PI) (IPPI) current controller; and
an IPPI voltage controller, wherein the IPPI current controller and the IPPI voltage controller incorporates both PI and IP control through a blending factor α.

13. The method of claim 12, wherein the blending factor α is optimized.

14. The method of claim 12, wherein the blending factor α is optimized to enhance damping characteristics and preserve stability for a desired system performance of the VSC subsystem.

15. The method of claim 12, wherein the blending factor α is optimized by solving:
$$\begin{matrix}{min}_{α} {\sum }_{m = 1}^{M} {σ}_{m} \\ s . t . \{ \begin{matrix}0 \leq {α}_{n} \leq 1 & ( n = 1 , 2 , … , N ) \\ \begin{matrix}{σ}_{0} \leq {σ}_{m} \leq 0 \\ {ζ}_{0} \leq {ζ}_{m}\end{matrix} & ( m = 1 , 2 , … , M )\end{matrix}\end{matrix}$$
where αₙ represents the blending factor of the IPPI current controller and the IPPI voltage controller for the nth VSC of the VSC subsystem, wherein M is the number of modes, wherein σ₀≤σₘ≤0 and ζ₀≤ζₘ are imposed simultaneously, wherein σₘ and ζₘ are a real part and damping ratios of the mth mode, respectively, wherein σ₀ and ζ₀ are corresponding desirable system performance metrics.

16. The method of claim 12, wherein solving for the optimized blending factor α utilizes a particle swarm optimization (PSO) technique.

17. The method of claim 12, wherein the IPPI voltage controller compares a reference output capacitor voltage with a measured output capacitor voltage to generate a VSC output current reference.

18. The method of claim 17, wherein the IPPI current controller compares the VSC output current reference with a measured VSC output current to generate a VSC output voltage.

19. The method of claim 12, wherein the IPPI voltage controller controls a voltage delivered to a micro grid (MG).

20. The method of claim 12, wherein the IPPI current controller controls a current delivered to a micro grid (MG).
